(19) United States
(12) Patent Application Publication
(10) Pub. No.: US 2026/0079548 A1
(43) Pub. Date: Mar. 19, 2026

(54) DIRECT HIGH-VOLTAGE USB POWER DELIVERY FOR SYSTEM STARTUP

(71) Applicant: Intel Corporation, Santa Clara, CA (US)

(72) Inventors: Santosh Gangal, Bengaluru (IN); Kannappan Rajaraman, Bangalore (IN); Jithin Valappilekandy, Bangalore (IN)

(21) Appl. No.: 19/398,267

(22) Filed: Nov. 24, 2025

(51) Int. Cl. G06F 1/26

(52) U.S. Cl. CPC G06F 1/26; H02J 1/082; H02J 2105/44

(57) ABSTRACT

A power delivery system is described that enables instant 20V/28V power delivery to sink devices by utilizing unique Configuration Channel (CC) resistor signatures to bypass standard power negotiation delays. The system may implement non-standard pull-down resistors (Rd) in sink devices and matching unique pull-up resistors (Rp) in source adapters to create CC voltages outside legacy USB PD specification ranges, instantly signaling full-power capability without traditional multi-step negotiations. Upon detecting such compatible unique signatures, the source may immediately apply a VBUS voltage of 20V or 28V at full current, eliminating the boot delays caused by standard USB PD negotiation processes. The system also avoids problematic sink standby (pSnkStdby) power consumption limitations that prevent dead battery boot scenarios. The system maintains backward compatibility through automatic fallback to standard USB PD negotiation when non-compliant devices are connected.

### BACKGROUND

Electronic devices are increasingly implementing power delivery architectures utilizing universal serial bus (USB) ports. These USB ports may use type-C connectors, which have been expanded to support higher power profiles. Such USB ports are typically coupled to a corresponding USB power delivery (PD) source, such as an AC-to-DC adapter or dock. The PD source thus provides power to the USB-coupled electronic device, referred to as a “sink device,” in accordance with one of several PD profiles, which represent a combination of a USB bus voltage (VBUS) value (e.g. 5V, 9V, 15V, 20V, 28V, 36V, 48V, etc.) and a maximum current value (e.g. 3 A, 5 A, etc.). The PD source thus sources power to the coupled sink device, which may include mobile devices such as laptops. The USB specification provides for a PD negotiating scheme in which a sink device (also referred to in some scenarios as a host device) may communicate with the PD source to negotiate for a specific PD profile, i.e. a specific combination of VBUS voltage and maximum current. However, as this PD negotiating scheme includes the exchange of messages between the PD source and sink device, such communications and corresponding VBUS adjustments may introduce latency into systems that need to establish a higher VBUS voltage PD profile for their operation.

For instance, USB PD-powered laptops may experience a few seconds of boot delay when starting from shutdown or a dead battery boot by adapter insertion. This is due to the required stepwise voltage negotiation process of the USB PD protocol, which requires that PD sources start at a VBUS voltage of 5V and then negotiate up to higher VBUS voltages such as 9V, 15V, or 20V (standard power range (SPR)) or 28V, 36V, or 48V (extended power range (EPR)) needed for powering up the system. This incremental process involves software handshakes and hardware switching from lower to higher power. That is, standard USB PD negotiation unconditionally starts by setting the default 5V as the VBUS voltage, which then moves to higher VBUS voltages only after several PD negotiation protocol exchanges. During these transitions, the sink device must drop power demand to pSnkStdby (˜2.5 W), which makes the boot sequence slower and riskier, as draws above pSnkStdby are not allowed until the VBUS voltage transition is complete. Thus, the current manner in which the USB specification handles higher VBUS requirements has various drawbacks, particularly for sink devices that immediately require a higher VBUS voltage to power on or transition to an operating state via a booting process.

### BRIEF DESCRIPTION OF THE DRAWINGS/FIGURES

The accompanying drawings, which are incorporated herein and form a part of the specification, illustrate the present disclosure and, together with the description, further serve to explain the principles and to enable a person skilled in the pertinent art to make and use the techniques discussed herein.

In the drawings, like reference characters generally refer to the same parts throughout the different views. The drawings are not necessarily to scale, emphasis instead generally being placed upon illustrating the principles of the disclosure. In the following description, reference is made to the following drawings, in which:

FIG. 1 illustrates a conventional USB power delivery (PD) system;

FIGS. 2A and 2B illustrate USB PD systems that leverage unique pull-up and pull-down resistors on the sink and source side to enable a direct transition to a higher VBUS voltage, in accordance with the disclosure;

FIG. 3 illustrates a block diagram of a USB PD system that supports direct transitioning to a higher VBUS voltage, in accordance with the disclosure, in accordance with the disclosure; and

FIG. 4 illustrates a process flow in accordance with the disclosure.

The present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

### I. USB Specification Overview

The Universal Serial Bus (USB) industry standard specifies both the physical interfaces and protocols for connecting, data transferring, and powering of hosts, such as personal computers, peripherals, mobile devices, intermediate hubs, etc. In July 2012, the USB Promoters Group announced the finalization of the USB Power Delivery (USB-PD) specification (USB PD rev. 1), an extension that specifies using certified PD aware USB cables with standard USB Type-A and Type-B connectors to deliver increased power (more than 7.5 W) to devices with greater power demands. Thus, USB-PD A and B plugs have a mechanical mark while micro plugs have a resistor or capacitor attached to the ID pin indicating the cable capability. Support for USB Type-C was finalized in August 2014 as part of the USB Type-C Specification 1.0. The USB Power Delivery specification revision 2.0 (USB PD Rev. 2.0) was released as part of the USB 3.1 suite, and provides power profiles having a VBUS voltage of 5, 9, 15, and 20V, with a maximum of 5 A for a maximum power delivery of 100 W. As part of this specification, the standard power range (SPR) power profiles were defined, i.e. USB-PD devices can request higher currents and supply voltages from compliant hosts—up to 2 A at 5V (for a power consumption of up to 10 W), and optionally up to 3 A or 5 A at either 12V (36 W or 60 W) or 20V (60 W or 100 W). In all cases, both host-to-device and device-to-host configurations are supported.

In May 2021, the USB PD promoter group launched revision 3.1 of the specification. Revision 3.1 adds the Extended Power Range (EPR) mode, which allows higher voltages of 28, 36, and 48V, providing up to 240 W of power (48V at 5A), and the “Adjustable Voltage Supply” (AVS) protocol that allows specifying the voltage from a range of 15 to 48V in 100 mV steps. The most recent USB PD specification as of the time of this writing is Revision 3.2, released in October 2023, which further refines the power rules and indicates making AVS mandatory for certain power ranges. Thus, the most recent USB PD source power rules at the time of this writing include the USB PD rev. 2.0, 3.1, and 3.2 source power rules, although the most recent USB data specification is the USB4 revision 2.0 released in September of 2022.

### II. Power Delivery and Power Profile Overview

The USB Power Delivery specification provided in accordance with the USB PD rev. 2.0/3.1/3.2 source power rules also defines a power negotiation scheme. This scheme enables a sink device (referred to as a host in this context) to request or “negotiate” an explicit “contract” between itself and a USB PD source in accordance with the capabilities of the PD source and the needs of the sink device. The contract may define a specific power profile, i.e. a combination of a VBUS voltage and current to be provided to the host to facilitate maximum power delivery. However, such USB PD negotiations require an exchange of both messages and, when the sink device negotiates for a new, fixed voltage level (e.g., changing from 5V to 20V, or 20V down to 9V), the sink device must also transition to a “Sink Standby” (pSnkStdby, ˜2.5 W) temporarily before the VBUS transitions to the new requested voltage level.

This transition from one fixed voltage to another involves a momentary change in the power supply output and, by reducing its load to the pSnkStdby level, the sink device ensures that an excessive current draw or voltage drop is introduced that could otherwise destabilize the VBUS voltage during the PD source ramp-up or ramp-down process. Although the Programmable Power Supply (PPS) feature introduced in USB PD 3.0 or the Adjustable Voltage Supply (AVS) in PD 3.1/3.2 may allow for smaller voltage adjustments (e.g., 20 mV or 100 mV steps) without the need to enter standby mode, many PD sources and sink devices are not compatible or do not support such PPS or AVS features. Thus, conventional USB PD systems typically require that the PD source and sink device start operations at a VBUS of 5V. then, several PD messages are exchanged via firmware/software intervention to enable the PD source to increase the VBUS voltage stepwise, with each step requiring PD handshakes between the PD source and the sink device and necessitating timeouts. Thus, the sink device must wait at each stage of negotiation and, when the sink device is a bootable device, an additional boot time of several seconds is thus needed before a higher VBUS voltage of 20V/28V may be supplied and booting may begin.

### III. USB Power Delivery Systems

The power delivery (PD) systems as discussed in further detail herein address these issues via a coordinated unique protocol signaling process that leverages a combination of a unique configuration channel (CC) line pull-up resistor Rd and a PD source CC line pull-down resistor Rp. That is, and as discussed in further detail herein, the sink device's PD controller may present (e.g. by adjusting one or more pull-down resistor values connected to the configuration channel (CC) line) a non-standard pull-down resistor Rd. A compliant PD source may then present (e.g. by adjusting one or more pull-up resistor values connected to the configuration channel (CC) line) a corresponding unique pull-up resistor Rp. This combination of unique Rp and Rd resistor values result in the CC line voltage being outside legacy ranges, instantly signaling full-power VBUS=20V/28V capability. Thus, if both sides detect the compatible signals (e.g. the unique non-standard CC line voltage), the PD source may immediately set the VBUS voltage to 20V/28V at full current, which bypasses the conventional usage of software and hardware staged-power increases and protocol delays.

In other words, when both unique resistor values Rp, Rd are present, the resulting unique CC line voltage instantly signals full power capabilities on both ends (i.e. the PD source and the sink device) based on the Rd detected by the PD source hardware. In response, the PD source may instantly deliver (i.e. directly transition to) providing the VBUS at 20V/28V at full current upon insertion of the USB cable, which entirely bypasses the incremental negotiation steps via software intervention as noted above. The result is a dramatic reduction in boot delay, e.g. a laptop/mobile system may receive operating voltage/power in milliseconds, not seconds, and may boot/charge without any enforced delay. As an illustrative scenario, the direct VBUS higher voltage VBUS transitioning PD systems as discussed herein may enable boots at full speed, in some cases going from plug to POST screen in less than a second. As a result, the PD systems as described herein thus directly address a significant consumer complaint regarding slow boot times when connecting a PD source to an unpowered or dead sink device, thereby reducing multi-second waits to provide a near-instant boot.

As a secondary benefit, the PD systems as described herein may enable advantages such as a faster boot time for applicable devices. This may include, in some scenarios, a fast boot time that is the result of the immediate (i.e. direct transitioning) to higher USB PD profiles that implement 20V and 28V VBUS voltage levels. This advantage stems from the elimination of the conventional multi-step PD negotiations, which reduces boot time and/or enables charging several seconds faster than conventional USB PD systems, creating a near “instant-on” experience from any power state.

For instance, the direct transition of the VBUS voltage means that the sink device does not need to enter into the pSnkStdby state during VBUS voltage adjustments, further improving reliability, especially with a dead battery. This is because, in accordance with the USB PD specification, the sink device must transition to the pSnkStdby state, which draws lower power (˜2.5 W) before the VBUS voltage transitions. This is problematic if the battery is dead, and the system needs more than 2.5 W to even begin booting or to power its PD controller. Thus, the PD systems as described herein may facilitate a reliable “dead-battery boot” for applicable devices by removing VBUS transitions and providing a direct VBUS transition to higher voltages such as 20V and 28V. In doing so, the PD systems as described herein avoid the sink standby (pSnkStdby) state, and thus the sink device does not need to limit power draw. This ensures full operation even from a truly dead battery, when meeting pSnkStdby would not be possible. As a result, by never requiring a VBUS transition, the PD systems as discussed herein avoid pSnkStdby requirements, ensuring robust and reliable dead-battery boot across split-rail and deeply discharged systems.

Furthermore, the PD systems as described herein may enable safety and compatibility with legacy systems. For instance, the PD systems as described herein may be implemented for sink devices and PD sources having 20V/28V VBUS capable hardware, although other PD profile combinations retain compatibility with USB PD specifications. For instance, if only one end (i.e. the PD source or the sink device) is compliant, or there is any mismatch in the resistor values, the CC voltage lands within USB PS specification defined CC line voltage ranges. In such a case, both the PD source and the sink device may revert safely and automatically to legacy, slow-negotiation behavior.

It is noted that although the PD systems are discussed in further detail herein in terms of the various versions of the current USB PD specification at the time of this writing, the PD systems are not limited to a specific protocol, standard, or connectors, and the PD profiles as discussed herein may comply with any of the USB power rules (i.e. power profiles). Moreover, the power delivery systems as discussed herein are not limited to the current USB standards, and may be implemented in accordance with newer USB specifications, standards, and/or revisions that are released after this writing. Thus, the PD systems as discussed herein, which again may utilize unique resistor values on the PD source and sink device sides, may operate in accordance with any of the current, future, or past USB PD specifications. However, the PD systems as discussed herein are not limited to implementation as part of a USB PD or to specific protocols, standards, specifications, or hardware connections, and may be implemented in accordance with any suitable power delivery system that may benefit from direct transitions to higher bus voltages.

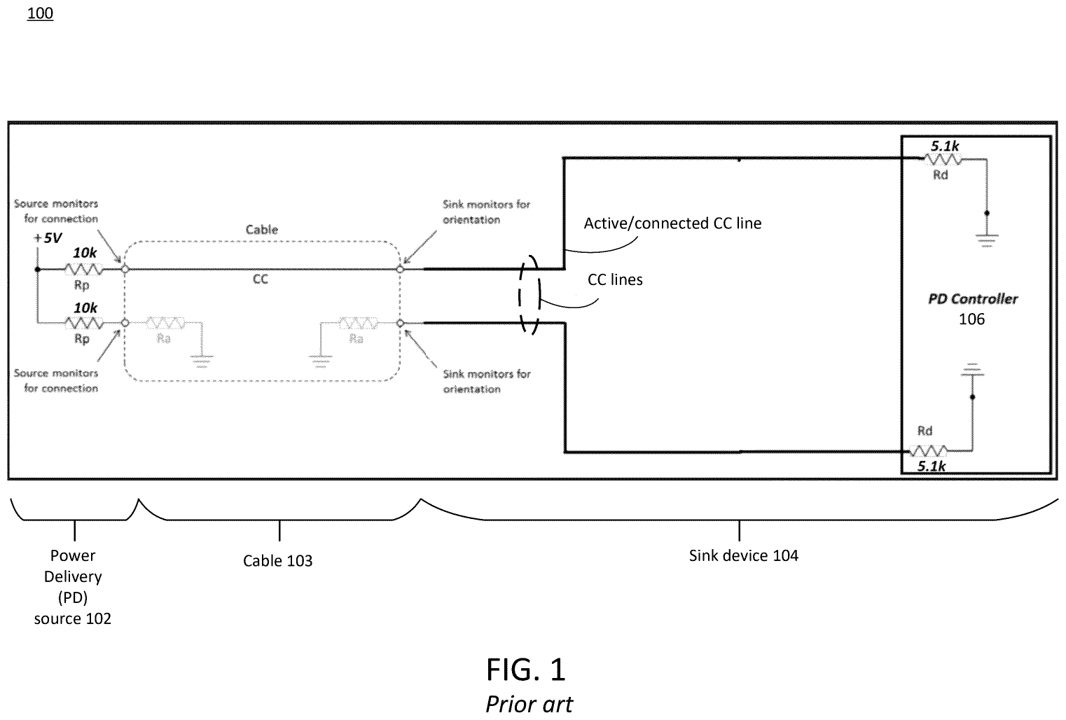

FIG. 1 illustrates a conventional USB power delivery (PD) system. The conventional power delivery system 100 as shown in FIG. 1 comprises a power delivery (PD) source 102 coupled to a sink device 104 via a USB compatible cable 103. The PD source 102 may be implemented as any suitable type of device that is configured to provide power to the sink device 104, as further discussed herein. The PD source 102 may comprise a USB power adapter, a dock (such as a thunderbolt dock), etc. The PD source 102 may be coupled to one or more ports of the sink device 104 via the cable 103.

The PD source 102 may be configured to be coupled to any of the ports of the sink device 104 via the cable 103 to provide power to the sink device 104 via one or more suitable interfaces. These interfaces may comprise the cable 103 and/or any suitable type of bus, wired connections, etc. The PD source 102 may be configured to deliver, via the cable 103, power to the sink device 104 via the coupled port in accordance with any suitable number of PD profiles. These PD profiles may comprise a combination of a VBUS voltage and current that complies with a USB PD profile specification as noted herein.

The sink device 104 may be implemented as any suitable type of electronic device that receives power from the PD source 102. In various non-limiting and illustrative scenarios, the sink device 104 may comprise a laptop computer, a tablet computer, a personal computer, a mobile device, a wearable electronic device, etc. The sink device 104 may implement any suitable number of ports, and power may thus be delivered by the PD source 102 via one or more such ports in accordance with a USB PD profile that complies with a USB PD profile specification. The VBUS voltage and current provided in this manner may be utilized by one or more components of the sink device 104 to provide system power, battery charging, etc.

As shown in FIG. 1, the cable 103 may include any suitable number of wires based upon the particular USB specification being implemented. For a USB Type-C interface, which is used throughout this disclosure as a non-limiting and exemplary implementation, these wires may include a pair of channel configuration (CC) lines as shown. The PD source 102 and the sink device 104 may include corresponding USB Type C ports, which function as interfaces to couple the various wires of the USB cable 103 to their respective pins and, in turn, to the circuitry of each device as shown. The cable 103 connects one of the two CC lines of the sink device 104 to a corresponding CC line of the PD source 102 to form a single active/connected CC line as shown. Thus, the cable 103 includes a single CC line connection that functions to electrically couple one of the corresponding CC pins CC1, CC2 of the PD source 102 to one of the CC pins CC1, CC2 of the sink device 104, with the active/connected CC line in this scenario being illustrated by the upper connected and continuous CC line as shown in FIG. 1.

The cable 103 may also include another, disconnected CC line that terminates each corresponding connected one of the CC1, CC2 pins to ground via a respective pull-down resistor Ra. That is, and as shown, the Ra pull-down resistors are integrated within the cable 103. The Ra pull-down resistors are typically about 1 kΩ and may be used to signal the presence of an e-marker (electronic marker) chip to the PD source 102 and to request VCONN power for the e-marker. Thus, due to the symmetric nature of the USB Type-C connector, only one of the corresponding CC1, CC2 pins of the PD source 102 and the sink device 104 are coupled to one another to form the active CC line, with the other CC pin (of CC1, CC2) being disconnected as shown in FIG. 1. The non-active CC line is thus used to supply power (VCONN) to the e-marker chip inside the cable 103 (not shown).

Thus, the connections between the CC pins CC1, CC2 are used in accordance with the USB specification to manage the connection, power delivery, and configuration between devices. Specifically, the active/connected one of the CC pins CC1 and CC2 facilitate a CC line that implements a system of pull-up (Rp) and pull-down (Rd) resistors to enable the PD source 102 to detect when the cable 103 has been physically connected. Additionally, because the Type-C connector is reversible, the sink device 104 may identify which one of the CC pins CC1, CC2 is connected to determine the correct orientation of the plug, and route the high-speed data lines (SuperSpeed and SBU) accordingly using internal switches or multiplexers (not shown).

Additionally, the PD source 102 and the sink device 104 may communicate via the connected CC line, and these communications may establish the roles of the connected devices. Thus, the PD source 102 and the sink device 104 may communicate with one another via the connected CC line using a bidirectional digital communication protocol that is defined in accordance with the USB specification. This negotiation ensures that both devices agree on a safe and optimal power contract.

For instance, the PD source 102 and the sink device 104 may establish power roles, i.e. which device will provide power (source, or DFP—Downstream Facing Port) and which will consume it (Sink, or UFP—Upstream Facing Port). In the non-limiting and illustrative scenario as shown in FIG. 1 and discussed herein, it is assumed that the PD source 102 is the power source and the sink device 104 is the sink. Furthermore, the communications via the connected CC line may establish which device acts as the host for data communication, and these roles may be dynamically swapped later using the USB Power Delivery (PD) protocol, known as Dual Role Power (DRP) or Dual Role Data (DRD).

The communications via the CC lines are also essential for managing power transfer via the VBUS line, which is also connected between the PD source 102 and the sink device 104 via the connected cable 103, although the VBUS connections are not shown in FIG. 1 for brevity. In various scenarios, the VBUS line may enable operations in accordance with multiple VBUS voltage levels as defined in accordance with the USB PD profile specification. This may include providing power via a basic 5V VBUS voltage up to the high-power capabilities of USB PD such as 9V, 12V, 15V, 20V, 28V, 28V, etc. (up to 240 W).

To do so, a current mode advertisement is implemented before full USB PD communications occur. This includes the PD source 102 advertising its initial current capabilities (default USB power, 1.5 A, or 3 A) using specific voltage levels that are set by the pull-up resistors Rp as shown. Additionally, the CC line communications may enable advanced functions such as setting the VBUS to higher voltages (9V, 12V, 15V, 20V, 28V, etc.), or establishing power delivery via a higher current value (such as up to 5 A). Such communications may include the measurement of a voltage level on the active CC line that is a result of the pull-down resistor Rp implemented by the sink device 104, which causes a specific voltage level on the active CC line that specifies a power level being requested by the sink device 104.

The various combinations of the pull-up resistor Rp values that establish corresponding voltage signatures for source PD 102 to advertise a specific PD power profile are shown in Table 1 below. The first three rows are defined in accordance with the USB PD specification, which result in a corresponding PD advertisement by the PD source 102 using the pull-up resistor values Rp as shown. However, the last row identifies Rp resistor values outside a range defined in accordance with a USB PD specification, as further discussed below, and thus is not recognized by the conventional USB PD system 100.

TABLE 1
Source CC termination (Rp) requirements

| | Current | Resistor | Resistor |
|---|---|---|---|
| Source | Source to | pull-up (Rp) to | pull-up (Rp) to |
| Advertisement | 1.7-5.5 V | 4.75-5.5 V | 3.3 V ± 5% |
| Default USB power | 80 μA ± 20% | 56 kΩ ± 20% | 36 kΩ ± 20% |
| 1.5 A @ 5 V | 180 μA ± 8% | 22 kΩ ± 5% | 12 kΩ ± 5% |
| 3.0 A @ 5 V | 330 μA ± 8% | 10 kΩ ± 5% | 4.7 kΩ ± 5% |
| 3.0 A @ 20 V | 560 μA ± 8% | 4.2 kΩ ± 5% | 1.2 kΩ ± 5% |

Additionally, Table 2 summarizes the various pull-down resistor Rd values implemented via the sink device 104 to establish corresponding voltage signatures to request various VBUS voltages and current levels for different source PD profiles. The first three rows are defined in accordance with the USB PD specification, which provides a resistor value specification for Rd to yield the corresponding maximum voltage on the CC line for a particular PD power profile. However, the last row identifies a resistor value specification for Rd that is outside that defined in accordance with a USB PD specification, and thus provides a voltage range on the CC line that is also outside that defined in accordance with a USB PD specification, as further discussed below. Thus, the Rd value in the last row of Table 2 is not recognized by the conventional USB PD system 100.

TABLE 2
Sink CC termination (Rd) requirements

| | Nominal | Can detect power | Max voltage |
|---|---|---|---|
| Rd implementation | value | capability? | on pin |
| ±20% voltage clamp | 1.1 V | No | 1.32 V |
| ±20% resistor to GND | 5.1 kΩ | No | 2.18 V |
| ±10% resistor to GND | 5.1 kΩ | Yes | 2.04 V |
| ±10% resistor to GND | 4.7 kΩ | Yes | 2.04 V |

Table 3 summarizes the various voltage ranges on the sink CC pins and corresponding detection mechanisms via corresponding resistor values for multiple source current advertisements. The first five rows are defined in accordance with the USB PD specification, which provides a range of voltages on the sink CC pins for a particular PD power profile. However, the last row identifies a voltage range specification resulting from the use of a specific Rd resistor value that is outside that defined in accordance with the USB PD specification, as further discussed below. Thus, the voltage range shown in the last row of Table 3 is not recognized by the conventional USB PD system 100.

TABLE 3
Voltage on sink CC pins (multiple source current advertisements)

| Detection | Min voltage | Max voltage | Threshold |
|---|---|---|---|
| vRa | −0.25 V | 0.15 V | 0.2 V |
| vRd-Connect | 0.25 V | 2.04 V | |
| vRd-USB | 0.25 V | 0.61 V | 0.66 V |
| vRd-1.5 | 0.70 V | 1.16 V | 1.23 V |
| vRd-3.0 | 1.31 V | 2.04 V | |
| vRd-3.0 (20 V) | 2.10 V | 3.10 V | |

Turning now back to FIG. 1, a scenario is shown in which the pull-up resistors Rp implemented via the PD source 102 are set to a value of 10 kΩ, and the pull-down resistors Rd implemented by the sink device 104 are set to a value of 5.1 kΩ. These values are represented in Tables 1 and 2 as corresponding to a PD source 102 advertisement of 3.0 A @5V. The value of 5.1 kΩ for the Rd resistor is thus recognized by the PD source 102 by measuring the voltage on the CC line, which has a corresponding maximum voltage of 2.04 V. Thus, once this CC voltage value is recognized by the PD source 102, the sink device 104 will then operate in accordance with a PD profile in which the VBUS voltage has 5V and a maximum of 3 A are supplied by the PD source 102.

However, it is noted that the use of these standard, recognized USB specification values requires a negotiation from the standard default USB PD profile, and may also require the sink device 104 to enter into the Sink Standby (pSnkStdby) state as noted above, which introduces latency particularly for booting operations. Additionally, and as noted herein, the PD negotiation process utilizes a stepwise voltage negotiation process that requires that the PD source 102 start at a VBUS voltage of 5V and then negotiate up to higher VBUS voltages such as 9V, 15V, or 20V (standard power range (SPR)) or 28V, 36V, or 48V (extended power range (EPR)) needed for powering up the system.

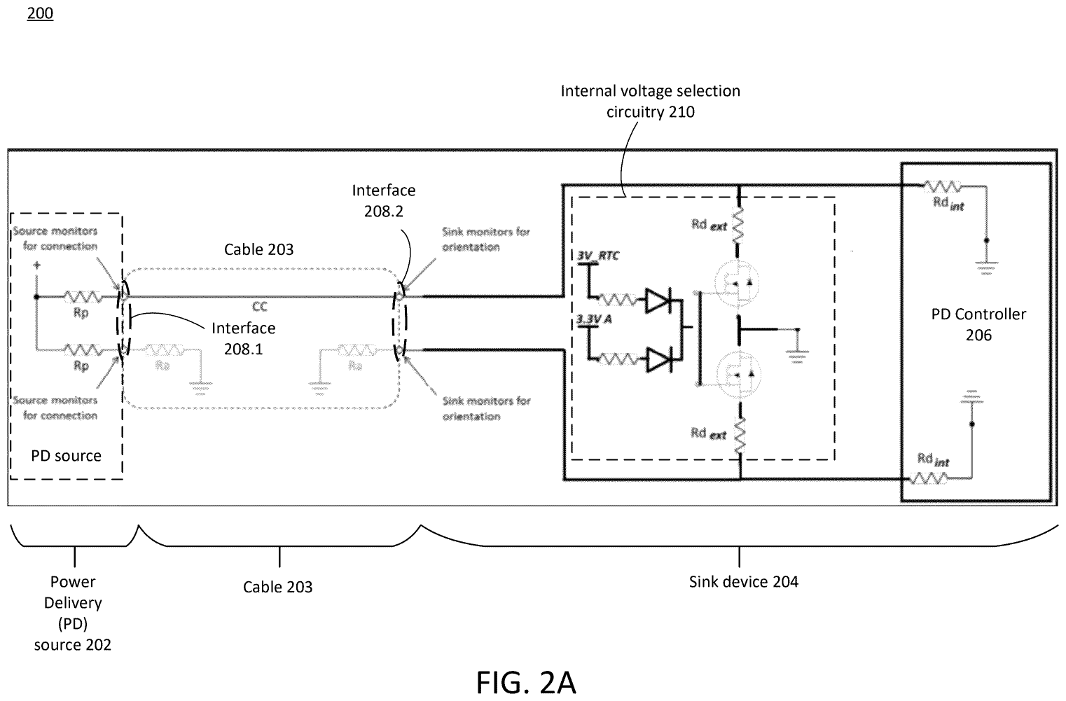

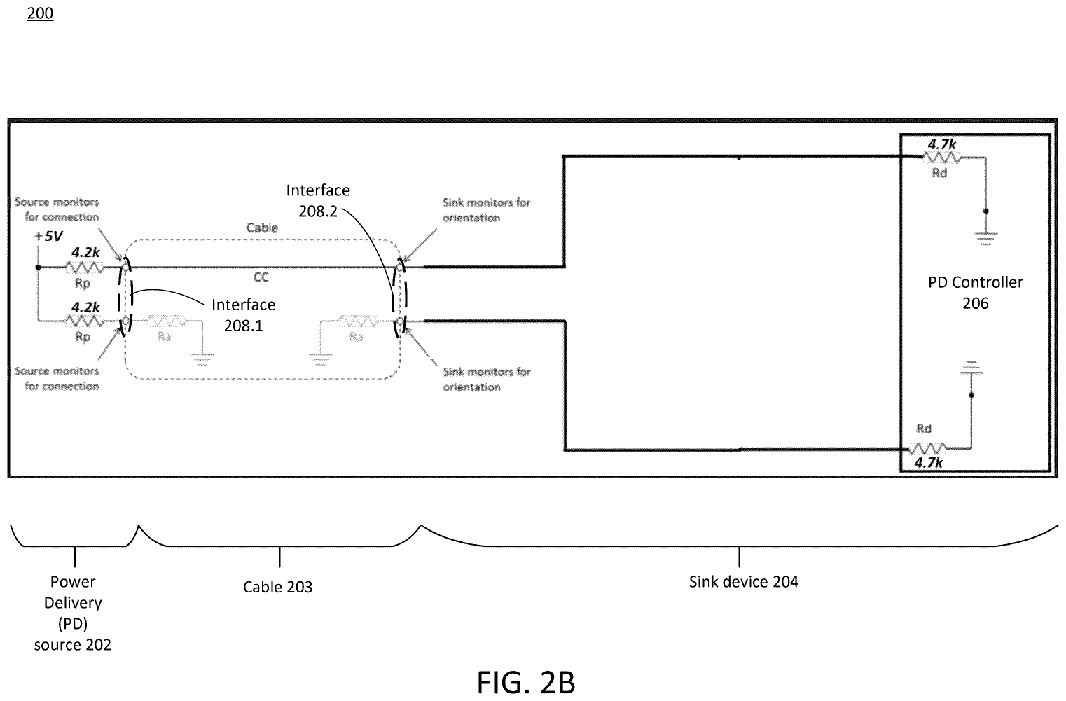

Thus, FIGS. 2A and 2B illustrate USB PD systems that leverage unique pull-up (Rp) and pull-down (Rd) resistors on the source and sink side to enable direct transitions from the default 5V VBUS voltage to a higher VBUS voltage such as 20V or 28V, in accordance with the disclosure. The USB PD systems 200, 250 as shown in FIGS. 2A and 2B may include similar or identical components as shown and discussed herein with respect to the conventional USB PD system 100, and thus any statements made with respect to the components of the conventional USB PD system 100 may likewise apply to those of the USB PD systems 200, 250, excepting for various differences in their operation as further discussed herein.

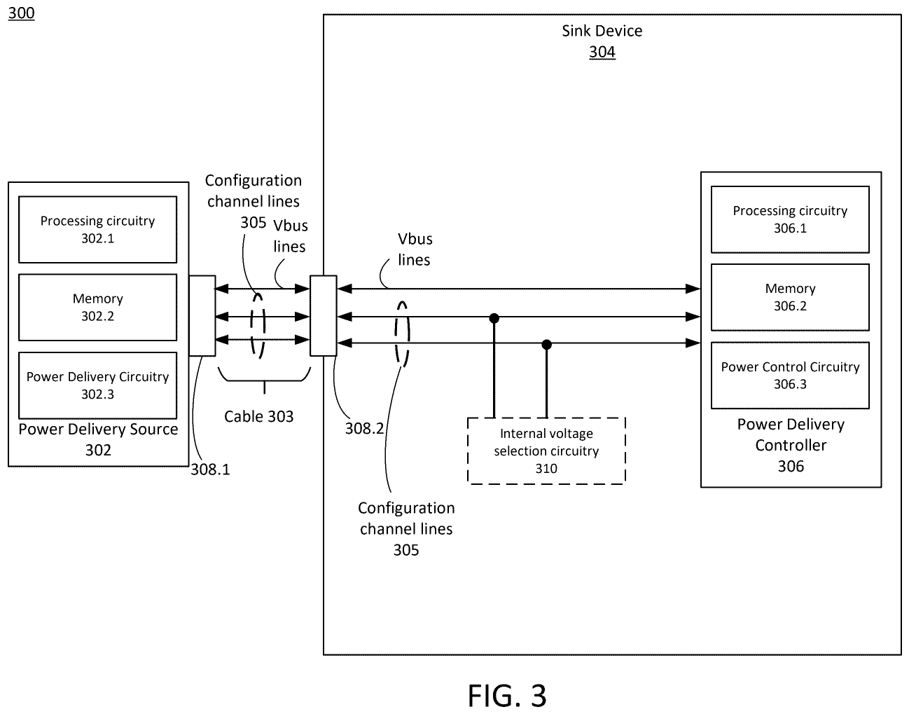

For instance, the USB PD systems 200, 250 may also include a PD source 202, a sink device 204, and a cable 203, which may be operate in a similar manner as the analogous PD source 102, sink device 104, and cable 103 of the conventional USB PD system 100. The USB PD systems 200, 250 may also include respective configuration channel interfaces 208.1, 208.2 for the PD source 202 and the sink device 204. The configuration channel interfaces 208.1, 208.2 may comprise any suitable number and/or type of electrical connections such as ports, terminals, pins, wires, etc. The configuration channel interfaces 208.1 may function to couple the PD source to the active CC line, whereas the configuration channel interface 208.2 may function to couple the PD controller 206 of the sink device 204 to the active CC line, as shown in FIGS. 2A and 2B. Furthermore, the PD source 202, sink device 204, and cable 203 may include additional or alternate components and function in a different manner than those described above with respect to the conventional USB PD system 100. These differences in operations may facilitate the various implementations discussed herein in which non-standard Rp, Rd resistor values and accompanying non-standard voltage ranges on the CC pins may be exploited to support direct higher power USB PD state transitioning. To provide some non-limiting and illustrative scenarios, this functionality may be realized by updating or otherwise modifying one or more components of the PD source 102 and/or the sink device 104, such as by updating the firmware, software, and/or hardware of the PD source 102 and/or the PD controller 106 from conventional device implementations. Doing so may facilitate the implementation of the PD source 202 and sink device 204 as discussed herein, and may thus enable the detection of the unique resistor and CC line voltage values as well as the direct transitioning of the VBUS voltage to higher voltage values. Additional details regarding the implementation and functionality of the PD source 202 and the PD controller 206 are discussed further below with respect to FIG. 3.

The USB PD systems 200, 250 illustrate separate configurations regarding how the resistor values for the unique, non-standard pull-down resistors Rd may be implemented within the sink device 204. However, for each of the USB PD systems 200, 250, each of the pull-up resistors Rp implemented via the PD source 202 and the pull-down resistors Rdext, Rdint, and Rp implemented via the PD source 202, as the case may be, may be implemented as any suitable type of resistor. This may include resistors that may be adjustable, have fixed values, or combination of these. For instance, any of the resistors Rd, Rdext, Rdint, and Rp may be implemented as a digitally-controlled adjustable resistor (which may be in combination with fixed resistor values) that may be adjusted at any suitable time. Thus, the values for the resistors Rd, Rdext, Rdint, and Rp may be adjusted to nonstandard (i.e. unique) resistor values or may resistor values that comply with the standard resistor values as defined in accordance with the USB PD specification, as discussed herein. These resistor value adjustments may be made in any suitable manner, such as via the PD source 202, the sink device 204, a separate controller (not shown), etc., and may be performed in accordance with any suitable techniques, including known techniques and/or those defined or otherwise implemented in accordance with the USB PD specification.

As shown in FIGS. 2A and 2B, the sink device 204 each of the USB PD systems 200, 250 includes a PD controller 206, which is configured to operate in accordance with various PD profiles that are defined by combinations of multiple VBUS voltage levels and current levels as discussed herein. Thus, the source 202 may be configured to deliver power via the VBUS line(s) (see FIG. 3) in accordance with multiple VBUS voltage and current levels, and the PD controller 206 and the sink device 204 may likewise be configured to operate in accordance with these various VBUS voltage and current levels as provided. Again, these VBUS voltage levels and current levels may comprise any suitable voltage and current levels, such as those defined in accordance with the USB PD specification. To provide some illustrative scenarios, the VBUS voltage levels may include 5V, 9V, 12V, 15V, 20V, 28V, 36V, 48V, etc., and the corresponding maximum current for providing power using these VBUS voltage levels may comprise 3 A or 5 A, or otherwise as defined by the USB PD specification. The PD controller 206 may be configured to communicate with the PD source 202 via the connected CC line, and to perform any suitable functions as discussed herein with respect to the sink device 204 identifying a PD profile and operating in accordance with a VBUS voltage as supplied by the PD source 202.

For instance, for both the USB PD systems 200 and 250, the PD controller 206 may be configured to set a pull-down resistor value to a specific, predetermined value that is typically not implemented, defined, and/or recognized in accordance with the USB PD specification (i.e. the pull-down resistor value differs from those defined in accordance with the USB PD specification). This resistor value, once set, causes a voltage drop on the active CC line such that the voltage level on this CC line is also outside a voltage range defined in accordance with the USB PD specification. The PD source 202 may thus recognize this unique, non-standard voltage level as a verification that the sink device 204 may support the direct transitioning of the VBUS voltage to an increased voltage level as discussed herein, and in response directly increase the VBUS voltage accordingly (e.g. to 20V, 28V, etc.). In response, the PD controller 206 may also directly transition (e.g. without entering a standby state and/or without utilizing PD negotiations) to operating from the default or initial VBUS voltage level (e.g. 5V) to this higher VBUS voltage level.

The pull-down resistor value that is set by the PD controller 206 to cause the desired voltage drop on the CC line may be represented by any suitable combination of resistor values associated with one or more resistors coupled to the CC line. In various illustrative scenarios, this pull-down resistor value may be represented as a combination of resistor values Rdext and Rdint as shown in 2A or, alternatively, as a single resistor value Rd as shown in FIG. 2B. Thus, and with reference to FIG. 2A, the pull-down resistor value may correspond to a parallel combination of resistor values of a resistor that is internal to the PD controller 206 (Rdint) and a resistor that is external to the PD controller 206 (Rdext).

Thus, in accordance with some scenarios, the sink device 204 may include internal voltage selection circuitry 210, which is wired in parallel with the PD controller 206 and the CC lines as shown. The internal voltage selection circuitry 210 is symmetric, i.e. each transistor is coupled to a separate CC line to enable operation regardless of the particular orientation of the USB Type-C plug and, accordingly, regardless of which of the CC pins CC1, CC2 is connected to the active CC line. The internal voltage selection circuitry 210 includes an arrangement of transistors having their respective gates coupled to the output of a logical “OR” circuit of parallel diodes. Thus, the parallel configuration of diodes couples the gate of each transistor to either a 3.3V internal voltage source (such as an internal DC voltage regulator) or, alternatively, a 3V real-time clock (RTC) battery source such as an onboard “coin cell” battery. Of course, the voltages provided are nonlimiting and illustrative, and the RTC battery and internal voltage source may be any suitable voltage values.

By providing the RTC battery source in parallel with the onboard internal voltage supply, it is ensured that the resistor Rdext provides a detectable voltage drop on the coupled active CC line in scenarios in which power is not supplied initially via the internal voltage supply, such as when the rechargeable battery of the sink device 204 is dead or contains a negligible charge. Thus, in the case of a dead rechargeable system battery, the Rdext resistor provides a voltage drop on the CC line via the RTC battery initially causing one of the coupled transistors to conduct, and then the internal voltage selection circuitry 210 switches to the internal voltage source afterwards. Thus, the Rdext resistor may be referred to herein as a dead battery pull-down resistor.

Thus, and to provide an illustrative scenario, the parallel combination of the resistors Rdext and Rdint may be set by the PD controller 206 (or other suitable component of the sink device 204) to provide an equivalent Rd resistance that is less than the standard Rd resistor values and/or outside the range of resistor values defined by the USB specification, such as those as shown in Table 2 above. Continuing this illustrative scenario, the equivalent Rd resistance may be set to 4.7 kΩ, which represents the value for Rd in the last row of Table 2 and results in a maximum voltage on the CC line that is less than and outside the range of the specified maximum CC voltage range as shown in Table 2.

The PD source 202 may then detect that the voltage level on the CC line exceeds a predetermined threshold voltage level based upon the current operating voltage (2.04 V in this case, which is greater than that defined in accordance with the USB PD specification). The PD source 202 may be configured, in response to detecting this condition, to directly transition to operate in accordance with a VBUS voltage level that exceeds (such as 20V, 28V, etc.) the lowest (such as 5V) one of the multiple VBUS voltage levels. The PD source 202 may be configured to so by adjusting the value of the pull-up resistor Rp to a resistor value that differs from that defined in accordance with a USB PD specification. To provide an illustrative scenario, the PD source 202 may adjust the resistance value of the pull-up resistor Rp to 4.2 kΩ, which represents the value for Rp in the last row of Table 1 (for a 4.75-5.5V system in this scenario) corresponding to a PD profile of a VBUS voltage of 20V at 3 A. Thus, the PD controller 206 may be configured to directly transition to operate in accordance with the higher VBUS voltage level supplied by the PD source 202, which again is 20V at 3 A in this scenario. Again, the direct transition in this scenario may include the PD source 202 operating in accordance with the higher VBUS level by supplying this VBUS voltage level in accordance with any suitable higher VBUS voltage setting, such as at 20V, 28V, etc., without performing PD negotiations with the sink device 204, without performing a multi-step voltage adjustment, and/or without the sink device 204 entering a standby state.

Turning now to FIG. 2B, the USB PD system 250 may function in the same manner as the USB PD system 200, although the resistance value of Rd, which again is represented by the parallel combination of Rdext and Rdint for the USB PD system 200, may alternatively be applied entirely within the PD controller 206 as shown. In other words, for the USB PD system 250, the pull-down resistor value corresponds to that of the resistor Rd that is internal to the PD controller 206. Such configurations may be particularly useful to avoid platform level modifications, as the PD controller 206 may set the value of Rd independently of any other components of the sink device 204.

It is noted that for both USB PD systems 200 and 250, the direct transition process for providing the higher level VBUS voltage may operate in the same manner, although the value of the resistor Rd may be represented differently. Thus, and as shown in FIG. 2B as an illustrative scenario, the resistor Rd may have a value set to 4.7 kΩ, which again represents the value for Rd in the last row of Table 2 and results in a maximum voltage on the CC line that is less than and outside the range of the specified maximum CC voltage range as shown in Table 2. Thus, by setting the value of Rd in this manner, the PD source 202 and the sink device 204 may directly transition to operating in accordance with the higher VBUS levels such as 20V, 28V, etc.

The configuration of the USB PD system 250 as shown in FIG. 2B also has the advantage of eliminating the internal voltage selection circuitry 210 as shown in FIG. 2A for the USB PD system 200. That is, by moving the pull-down resistor Rd entirely within the PD controller 206, which is coupled in series with each of the CC lines, it is ensured that a voltage drop will be supplied to the active CC line via the voltage supplied by the PD source 202. In this way, the USB PD system 250 may eliminate the need to provide auxiliary RTC battery power, thereby simplifying the design while reducing costs.

Thus, it is noted that both the PD source and the PD controller 206 may support direct transitions to operating in accordance with higher VBUS levels as noted herein, which may occur as part of a dead battery booting process. In this context, the “dead battery” may refer to that of the sink device 204, i.e. the voltage regulator identified with the 3.3V source as shown in FIG. 2A, which again may be identified with the rechargeable or system battery of the sink device 204. Advantageously, the direct VBUS higher voltage transition may occur in a manner that bypasses the sink device 204 entering the sink standby state, even for instances of dead battery booting. A summary of the combination of different resistor values representing the pull-up resistor Rp and the pull-down resistor Rd, which enable the direct transitioning to higher VBUS voltages as discussed herein, is provided in Table 4 below.

TABLE 4
Rp/Rd combinations and the unique combination
for supplying instant 20V+ VBUS

| PD Source | Sink Device | CC Voltage Range | Result |
|---|---|---|---|
| Standard Rp | Standard Rd | V1 | Standard PD, |
| | | | pSnkStdby applies |
| Unique Rp | Standard Rd | V2 | Standard PD, |
| | | | pSnkStdby applies |
| Standard Rp | Unique Rd | V3 | Standard PD, |
| | | | pSnkStdby applies |
| Unique Rp | Unique Rd | V_new | Instant 20V+, |
| | | | pSnkStdby bypassed |

FIG. 3 illustrates a block diagram of a USB PD system that supports direct transitioning to a higher VBUS voltage, in accordance with the disclosure. The USB PD system 300 may be identified with either of the USB PD systems 200, 250, and may also include a PD source 302, a sink device 304, a cable 303, and a PD controller 306, which may be operate in a similar manner as the analogous PD source 202, sink device 304, cable 103, and PD controller 206 of the USB PD systems 200, 250. The USB PD system 300 may also include respective CC interfaces 308.1, 308.2, which may be operate in a similar manner as the analogous CC interfaces 208.1, 208.2, and again may comprise any suitable number and/or type of electrical connections such as ports, terminals, pins, wires, etc. The CC interface 308.1 may function to couple the PD source 302 to the CC lines 305 and the VBUS lines, whereas the configuration channel interface 308.2 may function to couple the USB PD controller 306 of the sink device 304 to the CC lines 305 and the VBUS lines, as shown. The USB PD system 300 may optionally include the internal voltage selection circuitry 310, which may be identified with the internal voltage selection circuitry 210 of the USB PD system 200 when implemented in accordance with such a configuration.

The PD source 302 comprises processing circuitry 302.1, a memory 302.2, and power delivery circuitry 302.3. The processing circuitry 302.1 may be implemented as any suitable type of hardware circuitry, and may be implemented as any suitable number of processors, processing circuitry, hardware components, central processing units (CPUs), graphic processing units (GPUs), a host processor, a digital signal processor, one or more microprocessors, microcontrollers, an application-specific integrated circuit (ASIC), part (or the entirety of) a field-programmable gate array (FPGA), one or more chiplets, a system on a chip (SoC), etc. To provide additional illustrative scenarios, the processing circuitry 302.1 may be implemented as an embedded controller or any other suitable type of controller configured to perform the various functions as discussed in further detail herein. The processing circuitry 302.1 may comprise processing circuitry which may be configured as any suitable number and/or type of computer processors, which may function to control one or more other components of the PD source 302 as further discussed herein.

In any event, the processing circuitry 302.1 may be configured to carry out instructions to perform arithmetical, logical, and/or input/output (I/O) operations, and/or to control the operation of one or more components of the PD source 302 to perform the various functions as described herein. The processing circuitry 302.1 may include one or more microprocessor cores, memory registers, buffers, clocks, etc., and may generate electronic instructions and/or control signals that are transmitted to one or more components of the PD source 302 to control and/or modify the operation of these components. The processing circuitry 302.1 may additionally enable the transmission and/or reception of messages between the sink device 304, and may facilitate the measurement of CC line voltages. Additionally or alternatively, the processing circuitry 302.1 may enable the adjustment of any resistor values discussed herein, such as the pull-up resistors Rp for instance. The processing circuitry 302.1 may establish the power delivery profile and cause the power delivery circuitry 302.3 to provide power by setting the VBUS voltage level and an accompanying maximum current as discussed herein. This may include the direct transitioning and operation in accordance with the higher VBUS voltage levels as discussed herein.

The PD source 302 may comprise a memory 302.2, which may be implemented as any suitable type of memory that is configured to store data and/or instructions such that, when executed by the processing circuitry 302.1, cause the processing circuitry 302.1 (and thus the PD source 302) to perform various functions such as controlling, monitoring, and/or regulating the operation of one or more components of the PD source 302, which may include any of the functions as discussed herein with respect to the PD source 202. The memory 302.2 may be implemented as any suitable type of volatile and/or non-volatile memory, including read-only memory (ROM), random access memory (RAM), flash memory, a magnetic storage media, an optical disc, erasable programmable read only memory (EPROM), programmable read only memory (PROM), etc. The memory 302.2 may be non-removable, removable, or a combination of both. The memory 302.2 may be implemented as a non-transitory computer readable medium storing one or more executable instructions such as, for example, logic, algorithms, code, etc. These instructions, when executed by the processing circuitry 302.1, may enable any of the operations of the PD source 302, which may include any of the functions as discussed herein with respect to the PD source 202 to be functionally realized. Thus, any of the operations of the PD source 302, which may include any of the functions as discussed herein with respect to the PD source 202, may be realized via hardware (such as the processing circuitry 302.1) software (such as via the processing circuitry 302.1 executing instructions stored in the memory 302.2), or combinations of these.

The PD source 302 may comprise power delivery circuitry 302.3, which may be implemented as any suitable combination of hardware and/or software components configured to delivery power to the sink device 304. This may include one or more adjustable DC-DC converters, adjustable voltage sources, adjustable current sources, etc. The power delivery circuitry 302.3 may be configured to provide power by setting the VBUS voltage and maximum current to specific values as determined and/or instructed via the processing circuitry 302.1. This may include adjusting the VBUS voltage and/or current supply levels to enable the direct VBUS transitioning as discussed herein to higher VBUS voltage levels. Thus, the VBUS voltage may vary in accordance with any suitable range of voltage values. In a non-limiting and illustrative scenario, the VBUS voltage may vary between +5 and +48 volts in accordance with the USB power delivery specification as noted herein.

The PD controller 306 may comprise part of a system board, chip, SoC, etc., that is implemented by the sink device 304. The PD controller 306 may control and/or monitor the operation and functions of one or more components of the sink device 204 during its use. Thus, the PD controller 306 may likewise comprises processing circuitry 306.1, a memory 306.2, and power control circuitry 306.3. The processing circuitry 306.1 may be implemented as any suitable type of hardware circuitry, and may be implemented as any suitable number of processors, processing circuitry, hardware components, central processing units (CPUs), graphic processing units (GPUs), a host processor, a digital signal processor, one or more microprocessors, microcontrollers, an application-specific integrated circuit (ASIC), part (or the entirety of) a field-programmable gate array (FPGA), one or more chiplets, a system on a chip (SoC), etc. To provide additional illustrative scenarios, the processing circuitry 306.1 may be implemented as an embedded controller or any other suitable type of controller configured to perform the various functions as discussed in further detail herein. The processing circuitry 306.1 may comprise processing circuitry which may be configured as any suitable number and/or type of computer processors, which may function to control one or more other components of the PD controller 306 as further discussed herein.

The processing circuitry 306.1 may be configured to carry out instructions to perform arithmetical, logical, and/or input/output (I/O) operations, and/or to control the operation of one or more components of the PD controller 306 to perform the various functions as described herein. The processing circuitry 306.1 may include one or more microprocessor cores, memory registers, buffers, clocks, etc., and may generate electronic instructions and/or control signals that are transmitted to one or more components of the PD controller 306 to control and/or modify the operation of these components. The processing circuitry 306.1 may additionally enable the transmission and/or reception of messages between the PD source 302 and the sink device 304, and may facilitate the measurement of CC line voltages. Additionally or alternatively, the processing circuitry 306.1 may enable the adjustment of any resistor values discussed herein, such as the pull-down resistors Rd, Rdint, Rdext, for instance. The processing circuitry 306.1 may cause the power control circuitry 306.3 to adjust operation in accordance with an established VBUS voltage level at an accompanying current as discussed herein. This may include the direct transitioning and operation in accordance with the higher VBUS voltage levels as discussed herein.

The PD controller 306 may comprise a memory 306.2, which may be implemented as any suitable type of memory that is configured to store data and/or instructions such that, when executed by the processing circuitry 306.1, cause the processing circuitry 306.1 (and thus the PD controller 306) to perform various functions such as controlling, monitoring, and/or regulating the operation of one or more components of the PD controller 306, which may include any of the functions as discussed herein with respect to the PD controller 306. The memory 306.2 may be implemented as any suitable type of volatile and/or non-volatile memory, including read-only memory (ROM), random access memory (RAM), flash memory, a magnetic storage media, an optical disc, erasable programmable read only memory (EPROM), programmable read only memory (PROM), etc. The memory 306.2 may be non-removable, removable, or a combination of both. The memory 306.2 may be implemented as a non-transitory computer readable medium storing one or more executable instructions such as, for example, logic, algorithms, code, etc. These instructions, when executed by the processing circuitry 306.1, may enable any of the operations of the PD controller 306, which may include any of the functions as discussed herein with respect to the PD controller 206, to be functionally realized. Thus, any of the operations of the PD controller 306, which may include any of the functions as discussed herein with respect to the PD controller 206, may be realized via hardware (such as the processing circuitry 306.1) software (such as via the processing circuitry 306.1 executing instructions stored in the memory 306.2), or combinations of these.

The PD controller 306 may comprise power control circuitry 306.3, which may be implemented as any suitable combination of hardware and/or software components configured to adapt to the power delivered to the sink device 304. This may include one or more adjustable DC-DC converters, adjustable voltage sources, adjustable current sources, etc.

### IV. An Operational Flow

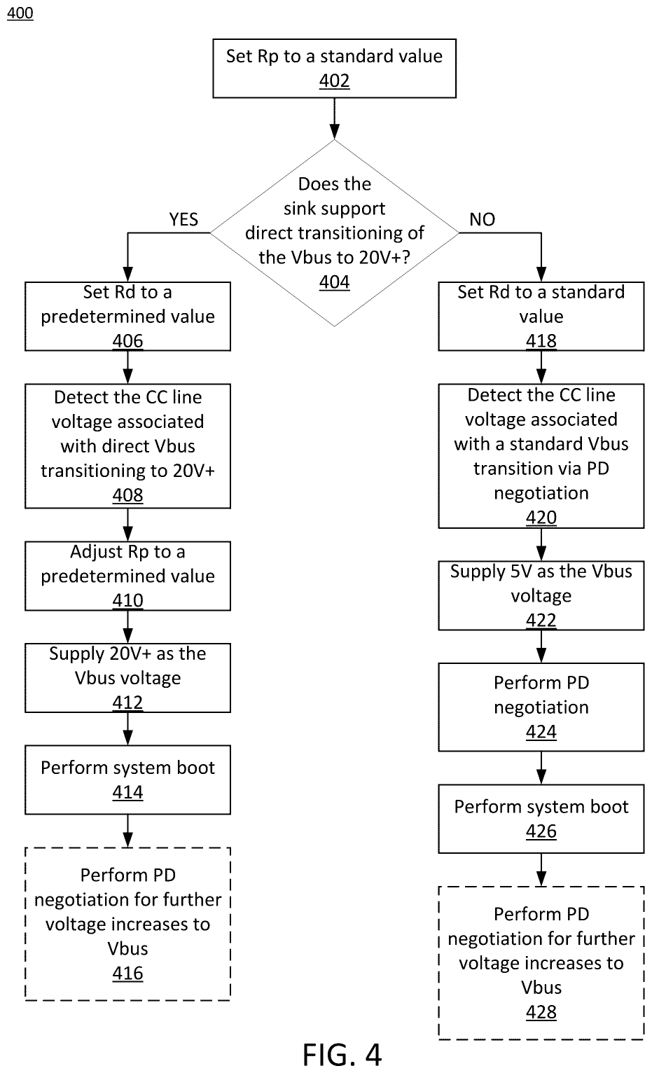

FIG. 4 illustrates a process flow in accordance with the disclosure. The various operations of the process flow 400 may be performed by any of the components as discussed herein, which may include the PD source 302/302, the sink device 204/304, the PD controller 206/306, or any other suitable components of the USB PD systems 200, 250, 300.

The process flow 400 may begin by setting (block 402) a pull-up resistor Rp to a standard value. This may include the PD source 202/302 setting the value of the resistor Rp to a predetermined standard value. This value may be determined in accordance with the USB PD specification and the current operating system voltage. Thus, for an operating voltage of 4.75-5.5 V, the value of the pull-up resistor Rp may be set to 56 kΩ to provide default USB power, as shown in Table 1.

The process flow 400 may further comprise a determination (block 404) of whether the sink device supports a direct transition to a higher VBUS power of 20V+. This may include a determination that may be performed via the PD controller 206/306, and may be based upon any suitable information that may be known by the sink device 204/304. For instance, the PD controller 206/306 may be preprogrammed or otherwise configured to recognize its capabilities and attempt to automatically establish a direct transition to a higher VBUS voltage when connected to a PD source.

In the case when the sink device 204/304 supports such direct VBUS higher voltage transitioning, the flow 400 includes setting (block 406) the pull-down resistor Rd to a predetermined value to cause a corresponding drop on the CC line. This may include, in various scenarios, setting the pull-down resistor Rd or the equivalent resistance Rd thereof (by setting the values of the external and internal resistors Rdext, Rdint) to a value that is not defined and/or is outside the range of resistance values for Rd defined by the USB PD specification.

The flow 400 may further comprise detecting (block 408) that the CC line voltage is associated with direct VBUS transitioning to a higher VBUS voltage level. This may include, in various scenarios, the PD source 202/302 measuring the CC line voltage in response to the pull-down resistor Rd being set. Again, when direct higher voltage VBUS transitioning is supported, the measured CC line voltage is outside the range of voltages as defined by the USB PD specification, as discussed herein, due to the unique value of Rd set by the PD controller 206/306.

The flow 400 may further include adjusting (block 410) the value of the pull-up resistor Rp to a predetermined value. This may include the PD source 202/302 setting the pull-up resistor Rp to a resistor value that is not defined and/or is outside the range of resistance values for Rp defined by the USB PD specification.

The flow 400 may further include supplying (block 412) the VBUS voltage in accordance with a voltage level that matches the unique voltage level of the CC line as a result of the unique Rd and Rp resistor values. Again, this may include the PD source 202/302 providing a VBUS voltage level at 20 or 28V with an accompanying maximum current.

The flow 400 may further include performing (block 414) a system boot, which may include a system boot of a suitable sink device such as a laptop. Again, this may include a dead battery boot, which may be performed using the directly supplied higher voltage level VBUS voltage without entering a standby state.

The flow 400 may further include optionally performing (block 416) PD negotiations. That is, subsequent full USB PD digital negotiation may still be performed during or after the system booting (block 414). This reserves the ability to support higher power (e.g., EPR 36V/48V) for advanced systems.

In the event that the sink device 204/304 does not support the direct VBUS higher voltage transitioning, the flow 400 includes setting (block 418) the pull-down resistor Rd to a predetermined value to cause a corresponding drop on the CC line. This may include, in various scenarios, setting the pull-down resistor Rd or the equivalent resistance Rd thereof (by setting the values of the external and internal resistors Rdext, Rdint) to a standard resistor value that is defined and/or is within the range of resistance values for Rd defined by the USB PD specification.

The flow 400 may further comprise detecting (block 420) that the CC line voltage is not associated with direct VBUS transitioning to a higher VBUS voltage level. This may include, in various scenarios, the PD source 202/302 measuring the CC line voltage in response to the pull-down resistor Rd being set. Again, when direct higher voltage VBUS transitioning is not supported, the measured CC line voltage is within the range of voltages as defined by the USB PD specification, as discussed herein, due to the standard value of Rd set by the PD controller 206/306.

The flow 400 may further include supplying (block 422) the VBUS voltage in accordance with a voltage level based upon that corresponding to the voltage level of the CC line as a result of the standard Rd (and Rp) resistor values. Again, this may include the PD source 202/302 providing the default/initial VBUS voltage level at 5V with an accompanying current.

The flow 400 may further include performing (block 424) PD negotiations. That is, several PD messages may be exchanged with the firmware/software intervention, and the PD source 202/302 may increase the VBUS voltage in a stepwise manner, with each step requiring PD handshakes and timeouts. Thus, the sink device 204/304 must wait at each stage of negotiation.

The flow 400 may further include performing (block 426) a system boot, which may include a system boot of a suitable sink device such as a laptop. However, due to the PD negotiations being completed (block 424) before the booting may occur, this introduces significant latency until the VBUS voltage may reach the desired 20/28V voltage value and booting may begin.

The flow 400 may further include optionally performing (block 428) further PD negotiations. Again, subsequent full USB PD digital negotiation may still be performed during or after the system booting (block 426), reserving the ability to support higher power (e.g., EPR 36V/48V) for advanced systems.

### V. General Configuration of a PD Source

An apparatus is provided. The apparatus comprises a Universal Serial Bus (USB) power delivery (PD) controller configured to operate in accordance with multiple VBUS voltage levels; and a configuration channel interface configured to couple the USB PD controller to a configuration channel line. The USB PD controller is configured to set a pull-down resistor value to cause a voltage level on the configuration channel line to be outside a voltage range defined in accordance with a USB PD specification, and to transition to operate in accordance with a VBUS voltage level from among the multiple VBUS voltage levels. In addition or in alternative to and in any combination with the optional features previously explained in this paragraph, the USB PD controller is configured, in response to causing the voltage level on the configuration channel line to be outside the voltage range defined in accordance with the USB PD specification, to directly transition to operate in accordance with the VBUS voltage level from among the multiple VBUS voltage levels. In addition or in alternative to and in any combination with the optional features previously explained in this paragraph, the VBUS voltage level is at least 20 volts. In addition or in alternative to and in any combination with the optional features previously explained in this paragraph, the VBUS voltage level is at least 28 volts. In addition or in alternative to and in any combination with the optional features previously explained in this paragraph, the USB PD controller is configured, in response to causing the voltage level on the configuration channel line to be outside the voltage range defined in accordance with the USB PD specification, to directly transition to operate in accordance with the VBUS voltage level from among the multiple VBUS voltage levels without utilizing PD negotiation. In addition or in alternative to and in any combination with the optional features previously explained in this paragraph, the pull-down resistor value differs from that defined in accordance with the USB PD specification. In addition or in alternative to and in any combination with the optional features previously explained in this paragraph, the pull-down resistor value corresponds to a parallel combination of resistor values of a first resistor that is internal to the USB PD controller and a second resistor that is external to the USB PD controller. In addition or in alternative to and in any combination with the optional features previously explained in this paragraph, the second resistor that is external to the USB PD controller comprises a dead battery pull-down resistor. In addition or in alternative to and in any combination with the optional features previously explained in this paragraph, the pull-down resistor value corresponds to a resistor value of a resistor that is internal to the USB PD controller. In addition or in alternative to and in any combination with the optional features previously explained in this paragraph, the apparatus comprises a USB sink device, and the USB PD controller is configured to directly transition to operate in accordance with the VBUS voltage level without entering a sink standby state. In addition or in alternative to and in any combination with the optional features previously explained in this paragraph, the USB PD controller is configured to directly transition to operate in accordance with the VBUS voltage level as part of a dead battery booting process.

### VI. General Configuration of a USB Sink Device

An apparatus is provided. The apparatus comprises a Universal Serial Bus (USB) power delivery (PD) source configured to deliver power in accordance with multiple VBUS voltage levels; and a configuration channel interface configured to couple the USB PD source to a configuration channel line. The USB PD source is configured, in response to detecting a voltage level on the configuration channel line that exceeds a predetermined threshold voltage level, to directly transition to operate in accordance with a VBUS voltage level that exceeds a lowest VBUS voltage level from among the multiple VBUS voltage levels without utilizing PD negotiation. In addition or in alternative to and in any combination with the optional features previously explained in this paragraph, the USB PD source is configured to detect the voltage level on the configuration channel line as a voltage drop across a resistor having a resistor value that differs from that defined in accordance with a USB PD specification. In addition or in alternative to and in any combination with the optional features previously explained in this paragraph, the USB PD source is configured to directly transition to operate in accordance with the VBUS voltage level by adjusting a pull-up resistor value to a resistor value that differs from that defined in accordance with a USB PD specification. In addition or in alternative to and in any combination with the optional features previously explained in this paragraph, the predetermined threshold voltage level is outside a voltage range defined in accordance with a USB PD specification. In addition or in alternative to and in any combination with the optional features previously explained in this paragraph, the VBUS voltage level is at least 20 volts. In addition or in alternative to and in any combination with the optional features previously explained in this paragraph, the VBUS voltage level is at least 28 volts. In addition or in alternative to and in any combination with the optional features previously explained in this paragraph, the voltage level on the configuration channel line that exceeds the predetermined threshold voltage level is a result of a sink side pull-down resistor value coupled to the configuration channel line that differs from that defined in accordance with a USB PD specification. In addition or in alternative to and in any combination with the optional features previously explained in this paragraph, the lowest VBUS voltage level from among the multiple VBUS voltage levels comprises 5 volts, and the PD source is configured to directly transition to operate in accordance with the VBUS voltage level comprising 20 or 28 volts. In addition or in alternative to and in any combination with the optional features previously explained in this paragraph, the USB PD source is configured to directly transition to operate in accordance with the VBUS voltage level as part of a dead battery booting process that bypasses a sink standby state.

### Examples

The following examples pertain to various techniques of the present disclosure.

An example (e.g. example 1), is directed to an apparatus comprising: a Universal Serial Bus (USB) power delivery (PD) controller configured to operate in accordance with multiple VBUS voltage levels; and a configuration channel interface configured to couple the USB PD controller to a configuration channel line, wherein the USB PD controller is configured to set a pull-down resistor value to cause a voltage level on the configuration channel line to be outside a voltage range defined in accordance with a USB PD specification, and to transition to operate in accordance with a VBUS voltage level from among the multiple VBUS voltage levels.

Another example (e.g. example 2), relates to a previously-described example (e.g. example 1), wherein the USB PD controller is configured, in response to causing the voltage level on the configuration channel line to be outside the voltage range defined in accordance with the USB PD specification, to directly transition to operate in accordance with the VBUS voltage level from among the multiple VBUS voltage levels.

Another example (e.g. example 3) relates to a previously-described example (e.g. one or more of examples 1-2), wherein the VBUS voltage level is at least 20 volts.

Another example (e.g. example 4) relates to a previously-described example (e.g. one or more of examples 1-3), wherein the VBUS voltage level is at least 28 volts.

Another example (e.g. example 5) relates to a previously-described example (e.g. one or more of examples 1-4), wherein the USB PD controller is configured, in response to causing the voltage level on the configuration channel line to be outside the voltage range defined in accordance with the USB PD specification, to directly transition to operate in accordance with the VBUS voltage level from among the multiple VBUS voltage levels without utilizing PD negotiation.

Another example (e.g. example 6) relates to a previously-described example (e.g. one or more of examples 1-5), wherein the pull-down resistor value differs from that defined in accordance with the USB PD specification.

Another example (e.g. example 7) relates to a previously-described example (e.g. one or more of examples 1-6), wherein the pull-down resistor value corresponds to a parallel combination of resistor values of a first resistor that is internal to the USB PD controller and a second resistor that is external to the USB PD controller.

Another example (e.g. example 8) relates to a previously-described example (e.g. one or more of examples 1-7), wherein the second resistor that is external to the USB PD controller comprises a dead battery pull-down resistor.

Another example (e.g. example 9) relates to a previously-described example (e.g. one or more of examples 1-8), wherein the pull-down resistor value corresponds to a resistor value of a resistor that is internal to the USB PD controller.

Another example (e.g. example 10) relates to a previously-described example (e.g. one or more of examples 1-9), wherein the apparatus comprises a USB sink device, and wherein the USB PD controller is configured to directly transition to operate in accordance with the VBUS voltage level without entering a sink standby state.

Another example (e.g. example 11) relates to a previously-described example (e.g. one or more of examples 1-10), wherein the USB PD controller is configured to directly transition to operate in accordance with the VBUS voltage level as part of a dead battery booting process.

An example (e.g. example 12) is directed to an apparatus comprising: comprising: a Universal Serial Bus (USB) power delivery (PD) source configured to deliver power in accordance with multiple VBUS voltage levels; and a configuration channel interface configured to couple the USB PD source to a configuration channel line, wherein the USB PD source is configured, in response to detecting a voltage level on the configuration channel line that exceeds a predetermined threshold voltage level, to directly transition to operate in accordance with a VBUS voltage level that exceeds a lowest VBUS voltage level from among the multiple VBUS voltage levels without utilizing PD negotiation.

Another example (e.g. example 13) relates to a previously-described example (e.g. example 12), wherein the USB PD source is configured to detect the voltage level on the configuration channel line as a voltage drop across a resistor having a resistor value that differs from that defined in accordance with a USB PD specification.

Another example (e.g. example 14) relates to a previously-described example (e.g. one or more of examples 11-13), wherein the USB PD source is configured to directly transition to operate in accordance with the VBUS voltage level by adjusting a pull-up resistor value to a resistor value that differs from that defined in accordance with a USB PD specification.

Another example (e.g. example 15) relates to a previously-described example (e.g. one or more of examples 11-14), wherein the predetermined threshold voltage level is outside a voltage range defined in accordance with a USB PD specification.

Another example (e.g. example 16) relates to a previously-described example (e.g. one or more of examples 11-15), wherein the VBUS voltage level is at least 20 volts.

Another example (e.g. example 17) relates to a previously-described example (e.g. one or more of examples 11-16), wherein the VBUS voltage level is at least 28 volts.

Another example (e.g. example 18) relates to a previously-described example (e.g. one or more of examples 11-17), wherein the voltage level on the configuration channel line that exceeds the predetermined threshold voltage level is a result of a sink side pull-down resistor value coupled to the configuration channel line that differs from that defined in accordance with a USB PD specification.

Another example (e.g. example 19) relates to a previously-described example (e.g. one or more of examples 11-18), wherein the lowest VBUS voltage level from among the multiple VBUS voltage levels comprises 5 volts, and wherein the PD source is configured to directly transition to operate in accordance with the VBUS voltage level comprising 20 or 28 volts.

Another example (e.g. example 20) relates to a previously-described example (e.g. one or more of examples 11-19), wherein the USB PD source is configured to directly transition to operate in accordance with the VBUS voltage level as part of a dead battery booting process that bypasses a sink standby state.

An example (e.g. example 21) is directed to an apparatus comprising: a Universal Serial Bus (USB) power delivery (PD) means for operating in accordance with multiple VBUS voltage levels; and a configuration channel interface means coupling the USB PD means to a configuration channel line, wherein the USB PD means sets a pull-down resistor value to cause a voltage level on the configuration channel line to be outside a voltage range defined in accordance with a USB PD specification, and to transition to operate in accordance with a VBUS voltage level from among the multiple VBUS voltage levels.

Another example (e.g. example 22), relates to a previously-described example (e.g. example 21), wherein the USB PD means, in response to causing the voltage level on the configuration channel line to be outside the voltage range defined in accordance with the USB PD specification, directly transitions to operate in accordance with the VBUS voltage level from among the multiple VBUS voltage levels.

Another example (e.g. example 23) relates to a previously-described example (e.g. one or more of examples 21-22), wherein the VBUS voltage level is at least 20 volts.

Another example (e.g. example 24) relates to a previously-described example (e.g. one or more of examples 21-23), wherein the VBUS voltage level is at least 28 volts.

Another example (e.g. example 25) relates to a previously-described example (e.g. one or more of examples 21-24), wherein the USB PD means, in response to causing the voltage level on the configuration channel line to be outside the voltage range defined in accordance with the USB PD specification, directly transitions to operate in accordance with the VBUS voltage level from among the multiple VBUS voltage levels without utilizing PD negotiation.

Another example (e.g. example 26) relates to a previously-described example (e.g. one or more of examples 21-25), wherein the pull-down resistor value differs from that defined in accordance with the USB PD specification.

Another example (e.g. example 27) relates to a previously-described example (e.g. one or more of examples 21-26), wherein the pull-down resistor value corresponds to a parallel combination of resistor values of a first resistor that is internal to the PD controller and a second resistor that is external to the PD means.

Another example (e.g. example 28) relates to a previously-described example (e.g. one or more of examples 21-27), wherein the second resistor that is external to the PD means comprises a dead battery pull-down resistor.

Another example (e.g. example 29) relates to a previously-described example (e.g. one or more of examples 21-28), wherein the pull-down resistor value corresponds to a resistor value of a resistor that is internal to the PD means.

Another example (e.g. example 30) relates to a previously-described example (e.g. one or more of examples 21-29), wherein the apparatus comprises a USB sink device, and wherein the USB PD means directly transitions to operate in accordance with the VBUS voltage level without entering a sink standby state.

Another example (e.g. example 31) relates to a previously-described example (e.g. one or more of examples 21-30), wherein the USB PD means directly transitions to operate in accordance with the VBUS voltage level as part of a dead battery booting process.

An example (e.g. example 32) is directed to an apparatus comprising: a Universal Serial Bus (USB) power delivery (PD) means for delivering power in accordance with multiple VBUS voltage levels; and a configuration channel interface means coupling the USB PD means to a configuration channel line, wherein the USB PD means, in response to detecting a voltage level on the configuration channel line that exceeds a predetermined threshold voltage level, directly transitions to operate in accordance with a VBUS voltage level that exceeds a lowest VBUS voltage level from among the multiple VBUS voltage levels without utilizing PD negotiation.

Another example (e.g. example 33), relates to a previously-described example (e.g. example 32), wherein the USB PD means detects the voltage level on the configuration channel line as a voltage drop across a resistor having a resistor value that differs from that defined in accordance with a USB PD specification.

Another example (e.g. example 34) relates to a previously-described example (e.g. one or more of examples 31-33), wherein the USB PD means directly transitions to operate in accordance with the VBUS voltage level by adjusting a pull-up resistor value to a resistor value that differs from that defined in accordance with a USB PD specification.

Another example (e.g. example 35) relates to a previously-described example (e.g. one or more of examples 31-34), wherein the predetermined threshold voltage level is outside a voltage range defined in accordance with a USB PD specification.

Another example (e.g. example 36) relates to a previously-described example (e.g. one or more of examples 31-35), wherein the VBUS voltage level is at least 20 volts.

Another example (e.g. example 37) relates to a previously-described example (e.g. one or more of examples 31-36), wherein the VBUS voltage level is at least 28 volts.

Another example (e.g. example 38) relates to a previously-described example (e.g. one or more of examples 31-37), wherein the voltage level on the configuration channel line that exceeds the predetermined threshold voltage level is a result of a sink side pull-down resistor value coupled to the configuration channel line that differs from that defined in accordance with a USB PD specification.

Another example (e.g. example 39) relates to a previously-described example (e.g. one or more of examples 31-38), wherein the lowest VBUS voltage level from among the multiple VBUS voltage levels comprises 5 volts, and wherein the PD means directly transitions to operate in accordance with the VBUS voltage level comprising 20 or 28 volts.

Another example (e.g. example 40) relates to a previously-described example (e.g. one or more of examples 31-39), wherein the USB PD means directly transitions to operate in accordance with the VBUS voltage level as part of a dead battery booting process that bypasses a sink standby state.

An example (e.g. example 41) is directed to a method comprising: operating, via a Universal Serial Bus (USB) power delivery (PD) controller, in accordance with multiple VBUS voltage levels; and coupling, via a configuration channel interface, the USB PD controller to a configuration channel line; setting, via the USB PD controller, a pull-down resistor value to cause a voltage level on the configuration channel line to be outside a voltage range defined in accordance with a USB PD specification; and transitioning, via the USB PD controller, to operating in accordance with a VBUS voltage level from among the multiple VBUS voltage levels.

Another example (e.g. example 42), relates to a previously-described example (e.g. example 41), further comprising: in response to causing the voltage level on the configuration channel line to be outside the voltage range defined in accordance with the USB PD specification, directly transitioning, via the USB PD controller, to operating in accordance with the VBUS voltage level from among the multiple VBUS voltage levels.

Another example (e.g. example 43) relates to a previously-described example (e.g. one or more of examples 41-42), wherein the VBUS voltage level is at least 20 volts.

Another example (e.g. example 44) relates to a previously-described example (e.g. one or more of examples 41-43), wherein the VBUS voltage level is at least 28 volts.

Another example (e.g. example 45) relates to a previously-described example (e.g. one or more of examples 41-44), further comprising: in response to causing the voltage level on the configuration channel line to be outside the voltage range defined in accordance with the USB PD specification, directly transitioning, via the USB PD controller, to operating in accordance with the VBUS voltage level from among the multiple VBUS voltage levels without utilizing PD negotiation.

Another example (e.g. example 46) relates to a previously-described example (e.g. one or more of examples 41-45), wherein the pull-down resistor value differs from that defined in accordance with the USB PD specification.

Another example (e.g. example 47) relates to a previously-described example (e.g. one or more of examples 41-46), wherein the pull-down resistor value corresponds to a parallel combination of resistor values of a first resistor that is internal to the USB PD controller and a second resistor that is external to the USB PD controller.

Another example (e.g. example 48) relates to a previously-described example (e.g. one or more of examples 41-47), wherein the second resistor that is external to the USB PD controller comprises a dead battery pull-down resistor.

Another example (e.g. example 49) relates to a previously-described example (e.g. one or more of examples 41-48), wherein the pull-down resistor value corresponds to a resistor value of a resistor that is internal to the USB PD controller.

Another example (e.g. example 50) relates to a previously-described example (e.g. one or more of examples 41-49), wherein the apparatus comprises a USB sink device, and further comprising: directly transitioning, via the USB PD controller, to operating in accordance with the VBUS voltage level without entering a sink standby state.

Another example (e.g. example 51) relates to a previously-described example (e.g. one or more of examples 41-50), further comprising: directly transitioning, via the USB PD controller, to operate in accordance with the VBUS voltage level as part of a dead battery booting process.

An example (e.g. example 52) is directed to a method comprising: delivering, via a Universal Serial Bus (USB) power delivery (PD) source, power in accordance with multiple VBUS voltage levels; coupling, via a configuration channel interface, the USB PD source to a configuration channel line; and in response to detecting a voltage level on the configuration channel line that exceeds a predetermined threshold voltage level, directly transitioning, via the USB PD source, to operating in accordance with a VBUS voltage level that exceeds a lowest VBUS voltage level from among the multiple VBUS voltage levels without utilizing PD negotiation.

Another example (e.g. example 53), relates to a previously-described example (e.g. example 52), further comprising: detecting, via the USB PD source, the voltage level on the configuration channel line as a voltage drop across a resistor having a resistor value that differs from that defined in accordance with a USB PD specification.

Another example (e.g. example 54) relates to a previously-described example (e.g. one or more of examples 52-53), further comprising: directly transitioning, via the USB PD source, to operating in accordance with the VBUS voltage level by adjusting a pull-up resistor value to a resistor value that differs from that defined in accordance with a USB PD specification.

Another example (e.g. example 55) relates to a previously-described example (e.g. one or more of examples 52-54), wherein the predetermined threshold voltage level is outside a voltage range defined in accordance with a USB PD specification.

Another example (e.g. example 56) relates to a previously-described example (e.g. one or more of examples 52-55), wherein the VBUS voltage level is at least 20 volts.

Another example (e.g. example 57) relates to a previously-described example (e.g. one or more of examples 52-56), wherein the VBUS voltage level is at least 28 volts.

Another example (e.g. example 58) relates to a previously-described example (e.g. one or more of examples 52-57), wherein the voltage level on the configuration channel line that exceeds the predetermined threshold voltage level is a result of a sink side pull-down resistor value coupled to the configuration channel line that differs from that defined in accordance with a USB PD specification.

Another example (e.g. example 59) relates to a previously-described example (e.g. one or more of examples 52-58), wherein the lowest VBUS voltage level from among the multiple VBUS voltage levels comprises 5 volts, and further comprising: directly transitioning, via the PD source, to operate in accordance with the VBUS voltage level comprising 20 or 28 volts.

Another example (e.g. example 60) relates to a previously-described example (e.g. one or more of examples 52-59), further comprising: directly transitioning, via the PD source, to operating in accordance with the VBUS voltage level as part of a dead battery booting process that bypasses a sink standby state.

An apparatus as shown and described.

A method as shown and described.

### CONCLUSION

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

What is claimed is:

1. An apparatus, comprising:
a Universal Serial Bus (USB) power delivery (PD) controller configured to operate in accordance with multiple VBUS voltage levels; and
a configuration channel interface configured to couple the USB PD controller to a configuration channel line,
wherein the USB PD controller is configured to set a pull-down resistor value to cause a voltage level on the configuration channel line to be outside a voltage range defined in accordance with a USB PD specification, and to transition to operate in accordance with a VBUS voltage level from among the multiple VBUS voltage levels.

2. The apparatus of claim 1, wherein the USB PD controller is configured, in response to causing the voltage level on the configuration channel line to be outside the voltage range defined in accordance with the USB PD specification, to directly transition to operate in accordance with the VBUS voltage level from among the multiple VBUS voltage levels.

3. The apparatus of claim 2, wherein the VBUS voltage level is at least 20 volts.

4. The apparatus of claim 2, wherein the VBUS voltage level is at least 28 volts.

5. The apparatus of claim 1, wherein the USB PD controller is configured, in response to causing the voltage level on the configuration channel line to be outside the voltage range defined in accordance with the USB PD specification, to directly transition to operate in accordance with the VBUS voltage level from among the multiple VBUS voltage levels without utilizing PD negotiation.

6. The apparatus of claim 1, wherein the pull-down resistor value differs from that defined in accordance with the USB PD specification.

7. The apparatus of claim 1, wherein the pull-down resistor value corresponds to a parallel combination of resistor values of a first resistor that is internal to the USB PD controller and a second resistor that is external to the USB PD controller.

8. The apparatus of claim 7, wherein the second resistor that is external to the USB PD controller comprises a dead battery pull-down resistor.

9. The apparatus of claim 1, wherein the pull-down resistor value corresponds to a resistor value of a resistor that is internal to the USB PD controller.

10. The apparatus of claim 2, wherein the apparatus comprises a USB sink device, and
wherein the USB PD controller is configured to directly transition to operate in accordance with the VBUS voltage level without entering a sink standby state.

11. The apparatus of claim 10, wherein the USB PD controller is configured to directly transition to operate in accordance with the VBUS voltage level as part of a dead battery booting process.

12. An apparatus, comprising:
a Universal Serial Bus (USB) power delivery (PD) source configured to deliver power in accordance with multiple VBUS voltage levels; and
a configuration channel interface configured to couple the USB PD source to a configuration channel line,
wherein the USB PD source is configured, in response to detecting a voltage level on the configuration channel line that exceeds a predetermined threshold voltage level, to directly transition to operate in accordance with a VBUS voltage level that exceeds a lowest VBUS voltage level from among the multiple VBUS voltage levels without utilizing PD negotiation.

13. The apparatus of claim 12, wherein the USB PD source is configured to detect the voltage level on the configuration channel line as a voltage drop across a resistor having a resistor value that differs from that defined in accordance with a USB PD specification.

14. The apparatus of claim 12, wherein the USB PD source is configured to directly transition to operate in accordance with the VBUS voltage level by adjusting a pull-up resistor value to a resistor value that differs from that defined in accordance with a USB PD specification.

15. The apparatus of claim 12, wherein the predetermined threshold voltage level is outside a voltage range defined in accordance with a USB PD specification.

16. The apparatus of claim 12, wherein the VBUS voltage level is at least 20 volts.

17. The apparatus of claim 12, wherein the VBUS voltage level is at least 28 volts.

18. The apparatus of claim 12, wherein the voltage level on the configuration channel line that exceeds the predetermined threshold voltage level is a result of a sink side pull-down resistor value coupled to the configuration channel line that differs from that defined in accordance with a USB PD specification.

19. The apparatus of claim 12, wherein the lowest VBUS voltage level from among the multiple VBUS voltage levels comprises 5 volts, and
wherein the PD source is configured to directly transition to operate in accordance with the VBUS voltage level comprising 20 or 28 volts.

20. The apparatus of claim 12, wherein the USB PD source is configured to directly transition to operate in accordance with the VBUS voltage level as part of a dead battery booting process that bypasses a sink standby state.
